(19) United States
(12) Patent Application Publication
(10) Pub. No.: US 2006/0280438 A1
(43) Pub. Date: Dec. 14, 2006

(54) Transmission stream transmitting/receiving system and control method thereof

(75) Inventor: Kwang-won Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/353,987

(22) Filed: Feb. 15, 2006

(30) Foreign Application Priority Data
Jun. 7, 2005 (KR) 2005-0048610

(51) Int. Cl. H04N 5/91

(52) U.S. Cl. 386/94

(57) ABSTRACT

A transmission stream transmitting/receiving system is provided. The transmission stream transmitting/receiving system includes a transmission stream transmitting apparatus to transmit a transmission stream including first viewing restriction information and viewing restriction insertion information; and a transmission stream receiving apparatus including a video extractor to extract a digital video signal from the transmission stream, a data processor to extract the viewing restriction insertion information and the first viewing restriction information from the transmission stream, an encoder to encode the digital video signal extracted by the video extractor into an analog video signal; and a controller to control the encoder to allow the first viewing restriction information extracted by the data processor to be included in the analog video signal based on the viewing restriction insertion information extracted by the data processorr.

### CROSS-REFERENCE TO RELATED APPLICATIONS

This application claims priority from Korean Patent Application No. 2005-0048610, filed on Jun. 7, 2005, in the Korean Intellectual Property Office, the disclosure of which is incorporated herein by reference.

### BACKGROUND OF THE INVENTION

1. Field of the Invention

The present invention relates to a transmitting stream transmitting/receiving system and a control method thereof, and more particularly, a transmission stream transmitting/receiving system and a control method thereof which comprises a transmitting apparatus to transmit a transmitting stream which comprises predetermined information together with a video signal and a receiving apparatus to receive them.

2. Description of the Related Art

Generally, digital broadcast signals comprise video and audio signals in a digital format and control information.

For example, an Advanced Television System Committee (ATSC) type digital broadcast signal includes the control information in program and system information protocol (PSIP) data.

The control information comprises viewing restriction information to indicate ratings of a digital broadcast program, thereby protecting children from indecent digital broadcast program content.

A digital broadcast signal receiving apparatus such as a digital television (DTV) may control the digital broadcast program to be displayed or not to be displayed on a TV screen according to internally set conditions by using the viewing restriction information.

Meanwhile, the DTV receives the digital broadcast signal to display the digital broadcast program on a screen thereof and encodes the digital broadcast signal into an analog signal to transmit it to external devices. Thus, the digital broadcast program may be provided to an external display apparatus through the DTV.

However, standards have not yet been prepared with respect to program and system information (PSIP) data, including the viewing restriction information included in the encoded analog signal. Even if broadcasting companies include the viewing restriction information in the PSIP data for every program, the analog signal encoded in the DTV may not comprise the viewing restriction information of the PSIP data.

Caption data including character information may also comprise the viewing restriction information. If the caption data and the PSIP data comprise the viewing restriction information respectively, (i.e. if the respective viewing restriction information of the caption data and the PSIP data are included in the encoded analog signal simultaneously) the video signal included in the analog signal may be distorted. Here, the distortion of the video signal may comprise time discrepancies between the image and the caption data. That is, the caption data may fail to be disposed in an appropriate region of the image due to a predetermined time delay.

### SUMMARY OF THE INVENTION

Illustrative, non-limiting embodiments of the present invention overcome the above disadvantages and other disadvantages not described above.

An aspect of the present invention is to provide a digital broadcast signal transmitting and receiving system which prevents distortion of a video signal generated when digital broadcast signal receiving apparatuses include the same viewing restriction information and two sets of viewing restriction information are encoded simultaneously in a case that the digital broadcast signal receiving apparatuses encode a digital broadcast signal into an analog signal.

According to an aspect of the present invention, there is provided a transmission stream transmitting/receiving system, including a transmission stream transmiting apparatus to transmit a transmission stream including first viewing restriction information and viewing restriction insertion information; and a transmission stream receiving apparatus including a video extractor to extract a digital video signal from the transmission stream, a data processor to extract the viewing restriction insertion information and the first viewing restriction information from the transmission stream, an encoder to encode the digital video signal extracted by the video extractor into an analog video signal to output it; and a controller to control the encoder to allow the first viewing restriction information extracted by the data processorr to be included in the analog video signal based on the viewing restriction insertion information extracted by the data processorr.

According to an aspect of the present invention, the transmission stream received from the transmission stream transmitting apparatus includes system information data and caption data; the viewing restriction insertion information and the first viewing restriction information are included in the system information data; and the system information data further includes caption data viewing restriction information to indicate whether the caption data includes second viewing restriction information.

According to an aspect of the present invention, the data processor further extracts the caption data and the caption data viewing restriction information of the system information data, from the transmission stream, and the controller removes the second viewing restriction information from the caption data before the analog video signal includes the first viewing restriction information extracted by the data processor if it is determined that the caption data includes the second viewing restriction information based on the caption data viewing restriction information extracted by the data processor.

According to an aspect of the present invention, the first viewing restriction information is included in the caption data without the second viewing restriction information, and the caption data is included in the encoded analog video signal.

According to an aspect of the present invention, the system information data is provided as program and system information protocol (PSIP) data.

According to an aspect of the present invention, there is provided a transmission stream transmitting apparatus to transmit a transmission stream including first viewing restriction information; and viewing restriction insertion information to indicate whether a video signal which is encoded in a transmission stream receiving apparatus includes the first viewing restriction information.

According to an aspect of the present invention, the transmission stream includes system information data and caption data; the viewing restriction insertion information and the first viewing restriction information are included in the system information data; and the system information data further includes caption data viewing restriction information to indicate whether the caption data includes second viewing restriction information.

According to an aspect of the present invention, there is provided a transmission stream receiving apparatus, including a video extractor to extract a digital video signal from a received transmission stream; a data processor to extract viewing restriction insertion information and first viewing restriction information form the transmission stream; an encoder to encode the digital video signal extracted by the video extractor into an analog video signal to output it; and a controller to control the encoder to allow the first viewing restriction information extracted by the data processor based on the viewing restriction insertion information extracted by the data processor to be included in the analog video signal.

According to an aspect of the present invention, the transmission stream includes system information data and caption data; the viewing restriction insertion information and the first viewing restriction information are included in the system information data; and the system information data further includes caption data viewing restriction information to indicate whether the caption data includes second viewing restriction information.

According to an aspect of the present invention, the data processor further extracts the caption data and the caption data viewing restriction information of the system information data, from the transmission stream; and the controller removes the second viewing restriction information from the caption data before the analog video signal includes the first viewing restriction information extracted by the data processor based on the viewing restriction insertion information if it is determined that the caption data includes the second viewing restriction information based on the caption data viewing restriction information extracted by the data processor.

According to an aspect of the present invention, the first viewing restriction information is included in the caption data without the second viewing restriction information, and the caption data is included in the encoded analog video signal.

According to an aspect of the present invention, there is provided a method of controlling a transmission stream receiving apparatus, including extracting a digital video signal from a received transmission stream; extracting viewing restriction insertion information and first viewing restriction information from the transmission stream; and encoding the extracted digital video signal into an analog video signal including the extracted first viewing restriction information based on the extracted viewing restriction insertion information, to output it.

According to an aspect of the present invention, the transmission stream includes system information data and caption data; the viewing restriction insertion information and the first viewing restriction information are included in the system information data; and the system information data further includes caption data viewing restriction information to indicate whether the caption data includes second viewing restriction information.

According to an aspect of the present invention, the method further includes extracting the caption data and the caption data viewing restriction information of the system information data from the transmission stream; and removing the second viewing restriction information from the caption data before the analog video signal includes the extracted first viewing restriction information based on the viewing restriction insertion information if it is determined that the caption data includes the second viewing restriction information based on the extracted caption data viewing restriction information.

### BRIEF DESCRIPTION OF THE DRAWINGS

The above and/or other aspects of the present invention will become apparent and more readily appreciated from the following description of the exemplary embodiments, taken in conjunction with the accompanying drawings of which:

FIG. 1 is a control block diagram of a transmission stream transmitting/receiving apparatus according to a first exemplary embodiment of the present invention;

FIG. 2 is a control block diagram of a transmssion stream transmitting/receiving apparatus according to a second exemplary embodiment of the present invention; and

FIG. 3 is a control flowchart of the transmission stream transmitting/receiving apparatus according to the second exemplary embodiment of the present invention.

### DETAILED DESCRIPTION OF EXEMPLARY EMBODIMENTS

Reference will now be made in detail to the exemplary embodiments of the present invention, examples of which are illustrated in the accompanying drawings, wherein like reference numerals refer to like elements throughout.

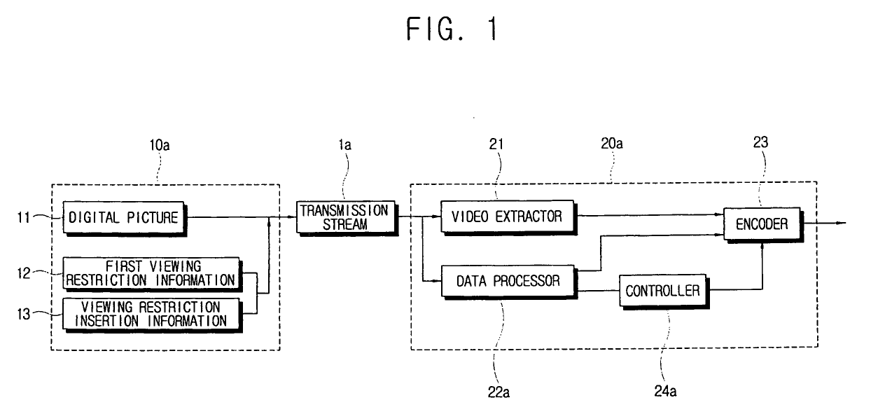

As shown in FIG. 1, a transmission stream transmitting/receiving system according to a first exemplary embodiment of the present invention comprises a transmission stream transmitting apparatus 10a to transmit a transmission stream including first viewing restriction information 12 and viewing restriction insertion information 13; and a transmission stream receiving apparatus 20a to receive and process a transmission stream 1a received from the transmission stream transmitting apparatus 10a.

The transmission stream received from the transmission stream transmitting apparatus 10a may be transmitted through a wired or wireless transmission path and may include a digital picture 11.

The first viewing restriction information 12 refers to information to indicate ratings of a video signal which is included in the transmission stream. The first viewing restriction information 12 blocks the video signal fundamentally according to predetermined conditions by using the ratings, thereby protecting children from indecent broadcast program content.

The viewing restriction insertion information 13 will be described together with a controller 24a of the transmission stream receiving apparatus 20a (to be described later).

The transmission stream receiving apparatus 20a may be provided as DTV, a set top box, etc. The transmission stream receiving apparatus 20a comprises a video extractor 21, a data processor 22a, an encoder 23 and the controller 24a.

Here, the video extractor 21 extracts a digital video signal from the transmission stream.

The data processor 22a extracts the viewing restriction insertion information 13 and the first viewing restriction information 12 from the transmission stream.

The encoder 23 encodes the digital video signal extracted by the video extractor 21 into an analog video signal to output it. The analog video signal output from the encoder 23 may be output to an external TV or display apparatuses outside the transmission stream receiving apparatus 20a in a composite video baseband signal (CVBS) or an S-video type.

The controller 24a controls the encoder 23 so that the first viewing restriction information 12 extracted by the data processor 22a is included in the analog video signal based on the viewing restriction insertion information 13 extracted by the data processor 22a.

The viewing restriction insertion information 13 determines whether the encoded analog video signal comprises the first viewing restriction information 12. The transmission stream transmitting apparatus 10a may comprise different viewing restriction insertion information 13 according to the video signal of the transmitted transmission stream.

For example, if the viewing restriction insertion information 13 is provided as a single bit, the transmission stream transmitting apparatus 10a stores a bit value of “1” when the transmission stream receiving apparatus 20a should include the first viewing restriction information 12 to the encoded analog video signal, and stores a bit value of “0” when the transmission stream receiving apparatus 20a should not include the first viewing restriction information 12 to the encoded analog video signal to transmit it.

Accordingly, the viewing restriction information included in the encoded analog video signal may be uniform, without varying based on the transmission stream receiving apparatus 20a.

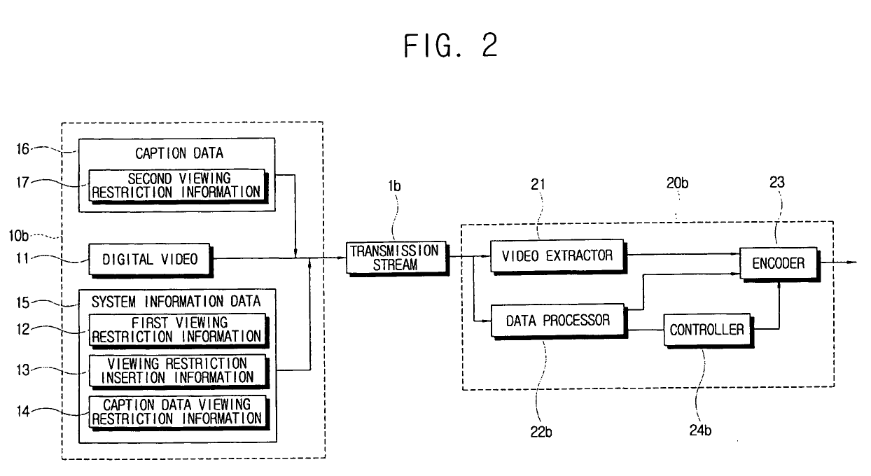

As shown in FIG. 2, a transmission stream transmitting/receiving system according to a second exemplary embodiment of the present invention comprises a transmission stream transmitting apparatus 10b to transmit a transmission stream comprising caption data 16 and system information data 15; and a transmission stream receiving apparatus 20b to receive and process a transmission stream 1b which is transmitted from the transmission stream transmitting apparatus 10b.

The caption data 16 comprises second viewing restriction information 17. The system information data 15 comprises first viewing restriction information 12; and caption data viewing restriction information 14 to indicate whether viewing restriction insertion information 13 and the caption data 16 comprise the second viewing restriction information 17.

An ATSC standard transmission stream will be described as an example of the present invention. The caption data 16 comprises character information such as a caption for the aurally challenged person and the system information data 15 comprise PSIP data.

The PSIP data refers to a small group of tables and comprises various information for all channels which are transmitted by the transmission stream. For example, the PSIP data comprises a system time table (STT) to represent information for current date and time, a virtual channel table (VCT) comprising channel names and numbers, etc. The viewing restriction insertion information 13 and the caption data viewing restriction information 14 may be added to one of the tables of the PSIP data.

Meanwhile, the transmission stream receiving apparatus 20b comprises a video extractor 21, a data processor 22b, an encoder 23 and a controller 24b.

Here, the video extractor 21 and the encoder 23 are the same as those described in the first exemplary embodiment of the present invention.

The data processor 22b extracts the first viewing restriction information 12, the viewing restriction insertion information 13, the caption data viewing restriction information 14 related to the caption data 16, and the system information data 15 from the transmission stream.

If it is determined that the caption data 16 comprises the second viewing restriction information 17 based on the caption data viewing restriction information 14 extracted by the data processor 22b, the controller 24b removes the second viewing restriction information 17 from the caption data 16 before the analog video signal comprises the first viewing restriction information 12 extracted by the data processor 22b based on the viewing restriction insertion information 13.

Also, the controller 24b may allow the caption data 16 without the second viewing restriction information 17 to comprise the first viewing restriction information 12, and allow the encoded analog video signal to comprise the caption data 16.

Thus, the analog video signal may avoid being distorted by having two sets of viewing restriction information in the encoded analog video signal.

The first viewing restriction information 12 included in the system information data 15 may apply to the encoded analog video signal prior to the second viewing restriction information 17 included in the caption data 16.

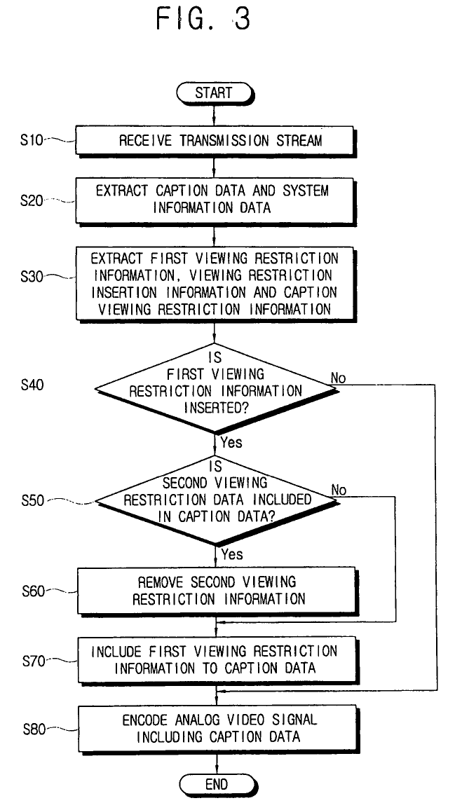

Referring to FIG. 3, the control flow of the transmission stream receiving apparatus 20b according to the second exemplary embodiment of the present invention will be described.

First, the transmission stream receiving apparatus 20b receives the transmission stream at operation S10 to extract the caption data 16 and the system information data 15 at operation S20.

The data processor 22b extracts the first viewing restriction information 12, the viewing restriction insertion information 13 and the caption data viewing restriction information 14 from the system information data 15 at operation S30.

When the first viewing restriction information 12 should be included in the encoded analog signal based on the extracted viewing restriction information at operation S40, the controller 24b determines whether the second viewing restriction information 17 is included in the caption data 16 based on the caption data viewing restriction information 14 at operation S50. If determined that the second viewing restriction information 17 is included in the caption data 16, the controller 24b removes the second viewing restriction information 17 from the caption data 16 at operation S60 so that the caption data 16 comprises the first viewing restriction information at operation S70.

Then, the encoder 23 encodes the analog video signal comprising the caption data 16 from the digital video signal to output it at operation S80.

If the first viewing restriction information 12 should not be included in the encoded analog signal based on the extracted viewing restriction information at operation S40, the encoder 23 allows the caption data 16, irrespective of the first viewing restriction information 12, to be included in the analog video signal to encode it at operation S80. At this time, the caption data 16 may comprise the second viewing restriction information 17.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A transmission stream transmitting and receiving system, comprising:
a transmission stream transmitting apparatus which transmits a transmission stream comprising first viewing restriction information and viewing restriction insertion information; and
a transmission stream receiving apparatus which receives the transmission stream from the transmission stream transmitting apparatus, the transmission stream receiving apparatus comprising:
a video extractor which extracts a digital video signal from the transmission stream;
a data processor which extracts the viewing restriction insertion information and the first viewing restriction information from the transmission stream;
an encoder which encodes the digital video signal extracted by the video extractor into an analog video signal; and
a controller which controls the encoder to include the first viewing restriction information extracted by the data processor in the analog video signal based on the viewing restriction insertion information extracted by the data processor.

2. The transmission stream transmitting and receiving system according to claim 1, wherein the transmission stream received from the transmission stream transmitting apparatus comprises system information data and caption data, wherein the viewing restriction insertion information and the first viewing restriction information are included in the system information data, and
wherein the system information data further comprises caption data viewing restriction information which indicates whether the caption data comprises second viewing restriction information.

3. The transmission stream transmitting and receiving system according to claim 2, wherein the data processor further extracts the caption data and the caption data viewing restriction information of the system information data, from the transmission stream, and the controller removes the second viewing restriction information from the caption data before including the first viewing restriction information extracted by the data processor in the analog video signal if it is determined that the caption data comprises the second viewing restriction information based on the caption data viewing restriction information extracted by the data processor.

4. The transmission stream transmitting and receiving system according to claim 3, wherein the first viewing restriction information is included in the caption data without the second viewing restriction information, and the caption data is included in the encoded analog video signal.

5. The transmission stream transmitting and receiving system according to claim 4, wherein the system information data is provided as program and system information protocol (PSIP) data.

6. A transmission stream transmitting apparatus comprising a transmitter which transmits a transmission stream comprising first viewing restriction information; and viewing restriction insertion information which indicates whether a video signal which is encoded in a transmission stream receiving apparatus comprises the first viewing restriction information.

7. The transmission stream transmitting apparatus according to claim 6, wherein the transmission stream comprises system information data and caption data; the viewing restriction insertion information and the first viewing restriction information are included in the system information data; and the system information data further comprises caption data viewing restriction information which indicates whether the caption data includes second viewing restriction information.

8. A transmission stream receiving apparatus comprising:
a video extractor which extracts a digital video signal from a received transmission stream;
a data processor which extracts viewing restriction insertion information and first viewing restriction information from the transmission stream;
an encoder which encodes the digital video signal extracted by the video extractor into an analog video signal; and
a controller which controls the encoder to include the first viewing restriction information extracted by the data processor in the analog video signal based on the viewing restriction insertion information extracted by the data processorr.

9. The transmission stream receiving apparatus according to claim 8, wherein the transmission stream comprises system information data and caption data;
wherein the viewing restriction insertion information and the first viewing restriction information are included in the system information data, and
wherein the system information data further comprises caption data viewing restriction information which indicates whether the caption data includes second viewing restriction information.

10. The transmission stream receiving apparatus according to claim 9, wherein the data processor further extracts the caption data and the caption data viewing restriction information of the system information data, from the transmission stream; and the controller removes the second viewing restriction information from the caption data before including the first viewing restriction information extracted by the data processor in the analog video signal based on the viewing restriction insertion information, if it is determined that the caption data includes the second viewing restriction information based on the caption data viewing restriction information extracted by the data processor.

11. The transmission stream receiving apparatus according to claim 10, wherein the first viewing restriction information is included in the caption data without the second viewing restriction information, and the caption data is included in the encoded analog video signal.

12. A method of controlling a transmission stream receiving apparatus, the method comprising:
extracting a digital video signal from a transmission stream;
extracting viewing restriction insertion information and first viewing restriction information from the transmission stream; and
encoding the digital video signal into an analog video signal which includes the extracted first viewing restriction information based on the extracted viewing restriction insertion information.

13. The method according to claim 12, wherein the transmission stream comprises system information data and caption data; the viewing restriction insertion information and the first viewing restriction information are included in the system information data; and the system information data further comprises caption data viewing restriction information which indicates whether the caption data comprises second viewing restriction information.

14. The method according to claim 13, further comprising:
extracting the caption data and the caption data viewing restriction information of the system information data, from the transmission stream; and
removing the second viewing restriction information from the caption data before including the extracted first viewing restriction information in the analog video signal based on the viewing restriction insertion information, if it is determined that the caption data includes the second viewing restriction information based on the extracted caption data viewing restriction information.
